(19) United States
(12) Patent Application Publication
(10) Pub. No.: US 2013/0008224 A1
(43) Pub. Date: Jan. 10, 2013

(54) METHOD FOR CALIBRATION OF A CO2 CONCENTRATION SENSOR AND A MEASURING DEVICE

(75) Inventor: Lars Stormbom, Vantaa (FI)

(73) Assignee: VAISALA OYJ, Helsinki (FI)

(21) Appl. No.: 13/576,107

(22) PCT Filed: Feb. 19, 2010
(86) PCT No.: PCT/FI2010/050110

§ 371 Date: Sep. 28, 2012

(51) Int. Cl. G01N 21/35; G01N 21/59

(52) U.S. Cl. 73/1.06; 356/437; 356/51

(57) ABSTRACT

This publication discloses a method for calibrating a CO2 concentration measuring device, in which method gas concentration is measured in a room. In accordance with the invention presence of persons is continuously determined in the room, and the measurement results are corrected based on the presence information.

The present invention relates to a calibration method according to the preamble of Claim 1.

The invention also relates to a measuring device.

WO2005015175 and WO9604607 show how drift of a CO₂ sensor used for demand controlled ventilation can be compensated by recording the measured values of the sensor over a longer time and assuming that the concentration of CO₂ in the space approaches the outdoor background concentration of approximately 400 ppm when the space is not occupied. The method described in WO2005015175 is here called also as ABC-method.

While this method works well in i.e. office buildings some other buildings—for example hospitals and railway stations—are often occupied most of the time. In such cases this drift compensation often has to be disabled because there is no guarantee that CO₂ content in the space approaches the outdoor background concentration (apr. 400 ppm).

The invention is intended to eliminate at least some defects of the state of the art disclosed above and for this purpose create an entirely new type of method for calibration of a CO₂ sensor and a measuring device.

The invention is based on combining CO₂ sensor with a movement sensor.

In such a sensor the signal from the movement sensor can be used to indicate when background (350-450 ppm) CO₂ concentration can be assumed. For instance >2 . . . 4 h without detected movement can indicate that background concentration can be assumed. This means that a low-cost IR CO₂-sensor without reference channel can be used.

Advantageously this movement sensor is e.g. an ultrasonic or passive infrared movement sensor so that ventilation can be started immediately when movement is detected.

More specifically, the method according to the invention is characterized by what is stated in the characterizing portion of Claim 1.

The apparatus according to the invention is, in turn, characterized by what is stated in the characterizing portion of Claim 12.

Considerable advantages are gained with the aid of the invention.

Te invention allows the use of a simple low-cost CO₂ sensor, for instance a sensor without reference channel. Therefore the total cost with a movement sensor can be reduced.

The invention provides more reliable operation than the prior art methods. In addition the invention is easy to use and install.

The invention improves also the accuracy of more advanced CO₂ sensors after several years of operation.

In the following, the invention is examined with the aid of examples and with reference to the accompanying drawings.

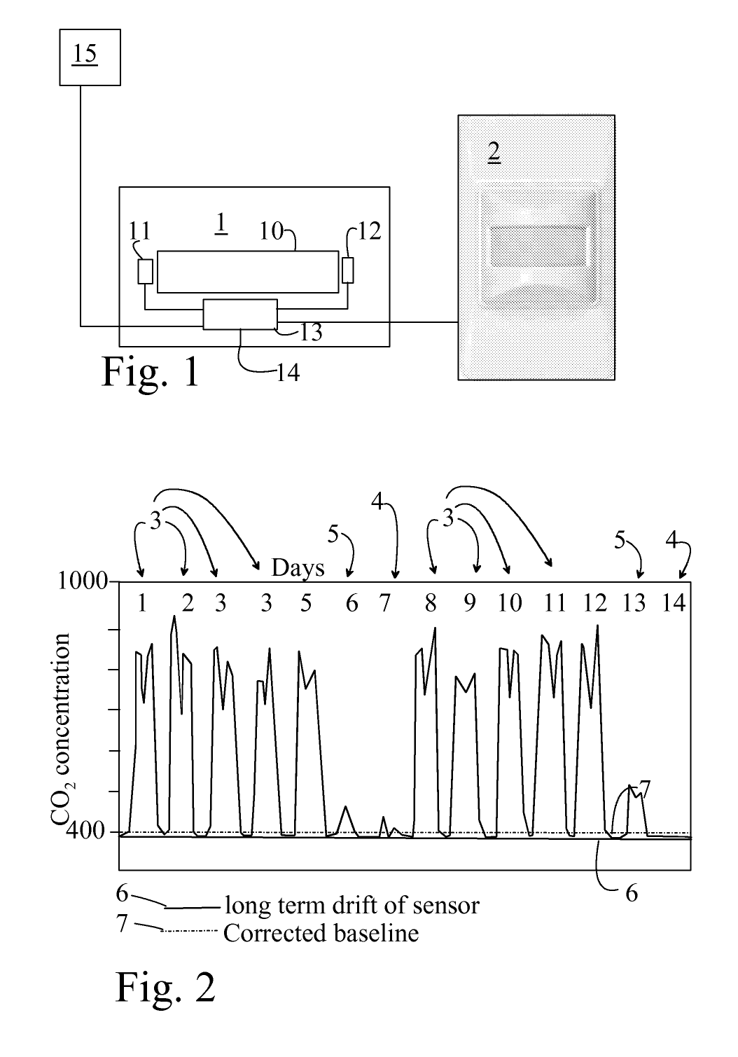

FIG. 1 shows a block diagram of one system according to the invention.

FIG. 2 shows graphically CO₂ concentration in a typical object for implementing the invention.

In accordance with the invention the measurement device typically contains the actual measurement instrument 1 and a movement detector 2 connected to it. The measurement instrument further includes typically a measurement chamber 10, a light source 11 situated in one end of the measurement chamber 10 and a light detector 12 at the other end of the measurement chamber 10. Further, the measurement device 1 comprises a control unit 13 for controlling the light source 11 and the detector 12 and has an input from the motion detector 2. The measurement chamber 10 is in gas connection to the ambient air and the content of desired gas like CO₂ is determined from the absorption of the light passing the measurement chamber 10. Typically the light arriving to the detector 12 is band-pass filtered such that it is sensitive to a characteristic wavelength of the gas to be measured. This can be done by a fixed filter or a electrically adjustable filter, e.g. a Fabry Perot filter (not shown). Typically NDIR-tehchnology (Nondispersive Infrared Sensor) is used for this purpose. This optical gas concentration measurement is known for the man skilled in the art.

The light source 11 and the detector 12 are connected to a control unit 13 for computing the gas concentration of the desired gas in the chamber 10. In accordance with the invention also a motion detector 2 is connected to the device 1, preferably to the control unit 13 of the device. The control unit 13 is typically a microprocessor. The connection from the sensor 2 to the unit 13 does not need to be direct, the control unit 13 needs only the information of the movement or presence sensor 2. Also a short delay for the presence information from the sensor 2 to control unit 13 (from milliseconds to minutes) is acceptable in connection with the invention because the changes in the CO₂ content are in practice rather slow. The measurement results are presented with a suitable display at the output 14 of the control unit 13.

In use of the measurement system e. g. in connection with a ventilation system, data from movement/presence sensor 2 is used to detect when it would be safe to assume that the room has been unoccupied long enough to assume that background (400 ppm) CO₂ level has been reached. The measurement system 1 can store values measured from the CO₂ sensor when the presence or movement sensor 2 has indicated no movement for a time longer than a threshold time (for instance 2-4 h).

In order to reduce too fast changes these low values may be stored for a longer period, say a month, and the moving average of these low values to indicate the necessary correction to the CO₂ measurement. Then, minimum of measured CO₂ during the day is recorded. Then, the output is corrected using an average minimum values recorded during the day, assuming that the concentration is at background (400 ppm) at such times. This background concentration can be e.g. a baseline corrected by a prior art ABC Logic of WO2005015175. This procedure might not be in buildings were there may be occupants at any time of the day, such as hospitals, hotels, train station etc. For such applications a prior art function often has to be switched off so as not to do false corrections.

In other words, in accordance with FIG. 2 CO₂ concentration of an office building is presented as a function of time. Line 6 represents long term drift of the measuring device 1. As can be seen from the figure during working days 3 (days number 1-5 and 8-12) there are two peaks of CO₂ concentration each day. On Saturdays 5 (days number 6 and 13) the concentration drops and on Sundays 4 (days number 7 and 14) the concentration is practically on background level 7. This happens also in the night time during other days. By the presence or movement sensor 2 the calibration can be made based on time of absence independently from the working cycles. This means that that the calibration can be repeated more frequently than in the prior art.

In accordance with one advantageous embodiment of the invention CO₂ measurement is corrected such that the average of a set of measurements obtained over several days when no movement signal has been detected for a time longer than a set minimum time equals the background concentration 7.

In addition to the calibration method, the movement sensor 2 can be used to start airflow at once on a low flow level when rooms are occupied, not waiting for CO₂ levels to increase. In other words, the control unit 13 of FIG. 1 may instruct the ventilation system of a room to start air flow once persons are detected in the room.

In large metropolises the background level might be higher than standard level and therefore in these situations it is advantageous to measure the actual background level. This could be implemented by the present invention by measuring the background content by another sensor 15 situated e.g., outside the building or in a pipe inlet of the ventilation system. This another sensor 15 would tell the exact background level into which the inside sensor should be adjusted, when there are no persons in the actual room where the measurement takes place.

In other words the presence sensor 2 would be used for determining the correct calibration time and the second sensor 15 for determining the background level to which the room CO₂ sensor should be adjusted. For telecommunications between the second sensor 15 and the room measuring device 1 could be used, e.g., field bus like BACnet.

The most advantageous alternative solution would be to put the additional sensor 15 into the inlet duct leading to the part of the building where the CO₂ sensors are. If the additional sensor 15 is placed after the mixed air dampers the influence of recirculated air to the CO₂ concentration in the gas flowing into the room is taken into account. Using recirculated air is done in order to save energy especially when the building unoccupied. In this case the unoccupied room where the measurement device 1 is situated does not represent real outdoor background value and therefore either a fixed background value or inlet duct sensor 15 should be used to correct the situation.

1. A calibration method for a CO₂ concentration measuring device, in which method
CO₂ concentration is measured in a room, wherein
presence of persons is continuously detected in the room, and
the measurement results are corrected based on the presence information.

2. A method in accordance with claim 1, wherein if no persons are detected within a predetermined time the output of the device is set to background value of CO₂ concentration.

3. A method in accordance with claim 1, wherein as a background level is used concentration of 300-500 ppm.

4. A method in accordance with claim 1, wherein background level is determined by another CO₂ sensor positioned in a place representing real background level.

5. A method in accordance with claim 1, wherein the second sensor is positioned outside the building where the measurement room is situated.

6. A method in accordance with claim 1, wherein the second sensor is positioned in an inlet duct supplying air to the building or part of the building where the measurement room is situated.

7. A method in accordance with claim 1, wherein NDIR-tehcnology is used in the measuring device.

8. A method in accordance with claim 1, wherein as a presence or movement sensor is used ultrasonic sensor or passive infrared (PIR) sensor.

9. A method in accordance with claim 1, wherein the measurement is corrected to the background value when the no movement has been detected for several hours, preferably not within more than 2 hours, most preferably not within more than 4 hours.

10. A method in accordance with claim 1, wherein the CO₂ measurement is corrected such that the average of a set of measurements obtained over several days when no movement signal has been detected for a time longer than a set minimum time equals the background concentration.

11. A method in accordance with claim 1, wherein presence or movement sensor is used for the switching on ventilation in a room to be measured when a person is detected.

12. A measurement device including
means for CO₂ concentration measurement,
control means for defining a gas concentration,
wherein
the device includes also a presence of movement detector connected to the control means.

13. A device in accordance with claim 12, wherein it includes means for setting the output of the device to background value of CO₂ concentration if no persons are detected within a predetermined time.

14. A device in accordance with claim 12, wherein as a background level is used concentration of 300-500 ppm.

15. A device in accordance with claim 12, wherein it includes another CO₂ sensor for determining the background level positioned in a place representing real background level.

16. A device in accordance with claim 12, wherein the second sensor is positioned outside the building where the measurement room is situated.

17. A device in accordance with claim 12, wherein the second sensor is positioned in an inlet duct supplying air to the building or part of the building where the measurement room is situated.

18. A device in accordance with claim 12, wherein the measuring device is implemented by NDIR-technology.

19. A device in accordance with claim 12, wherein as a presence or movement sensor is used ultrasonic sensor or passive infrared (PIR) sensor.

20. A device in accordance with claim 12, wherein it includes means for correcting the measurement to the background value when the no movement has been detected for several hours, preferably not within more than 2 hours, most preferably not within more than 4 hours.

21. A device in accordance with claim 12, wherein includes means for correcting CO₂ measurement such that the average of a set of measurements obtained over several days when no movement signal has been detected for a time longer than a set minimum time equals the background concentration.

22. A device in accordance with claim 12, wherein it includes means for using presence or movement sensor for the switching on ventilation in a room to be measured when a person is detected.
